(19) United States
(12) Patent Application Publication
(10) Pub. No.: US 2012/0058447 A1
(43) Pub. Date: Mar. 8, 2012

(54) INTERDENTAL WEDGE

(75) Inventors: Uwe Liener, Midlum (DE); Manfred Thomas Plaumann, Cuxhaven (DE)

(73) Assignee: VOCO GmbH, Cuxhaven (DE)

(21) Appl. No.: 13/227,609

(22) Filed: Sep. 8, 2011

(30) Foreign Application Priority Data
Sep. 8, 2010 (DE) 10 2010 040 414.4

(51) Int. Cl. A61C 5/04

(52) U.S. Cl. 433/149

(57) ABSTRACT

The invention relates to an interdental wedge for use with a matrix band when preparing a filling on a tooth to be restored and/or for use with a rubber dam, by inserting the interdental wedge into an area near the gingiva between the tooth to be restored or to be treated and an adjacent tooth, with an insertion area having a cross section delimited by a lower face, by an inner face and by an outer face, wherein, in the state inserted near the gingiva, the lower face is directed towards the gum, the inner face is directed towards the tooth to be restored or to be treated, and the outer face is directed towards the adjacent tooth, wherein the inner face and the lower face run together in an edge, which is designed such that, in the state inserted near the gingiva, it bears on the tooth to be restored or to be treated, in order to provide a sealing action against passage of material.

### CROSS-REFERENCE TO RELATED APPLICATIONS

This application claims priority to German Patent Application No. DE 10 2010 040 414.4, filed Sep. 8, 2010, the entire contents of which are incorporated herein by reference.

### FIELD OF THE INVENTION

The invention relates to an interdental wedge for use with a matrix band when preparing a filling (in particular a dental filling) on a tooth to be restored, by inserting the interdental wedge into an area near the gingiva between the tooth to be restored and an adjacent tooth, and a particular aim of the invention is to make available an anatomically shaped interdental wedge that permits improved filling treatment and/or endodontic treatment.

### BACKGROUND OF THE INVENTION

In the field of dentistry, there are various tooth restoration methods. For many fillings, after the diseased tooth substance has been removed, a matrix band has to be placed around the laterally opened tooth and is secured, for example, with a matrix retainer. Such matrix bands can be made, inter alia, of very thin metal film. The metal film can be secured, for example, with a Tofflemire matrix retainer. In this system, the matrix band is placed like a loop around the prepared tooth and is then tightened with a clamping device. It thus bears firmly and radially on the circumference of the prepared tooth. When the filling procedure is being carried out, the matrix band, at the places where the tooth was laterally opened, functions as a boundary wall for the filling material and finally forms the outwardly visible surface of the filling.

However, since teeth are not cylindrical and instead often have a cross section increasing from the gum towards the occlusal surface, the use of matrix bands made of metal often leads to leaks in the area near the gingiva, i.e. near the gum.

The filling materials used are often pasty, highly viscous substances, although low-viscosity substances called flow materials are also increasingly being used. These are introduced into the cavity, plugged and then, for example, hardened by light. At unsealed locations between matrix band and tooth, filling material can then escape and also hardens when exposed to the light. This filling material that has escaped and hardened then has to be removed manually. Since such removal is generally awkward and is also unpleasant for the patient, the escape of filling material in the first place is undesirable.

The removal of an excess amount of filling material is particularly difficult in areas where an adjacent tooth impedes access. For this reason, interdental wedges are used in such areas. These small wedges are placed between the teeth before the filling procedure and are intended to press the matrix band more or less firmly against the neck of the tooth, in order in this way to minimize leaks.

Examples of known wedges include small wooden wedges that have a substantially straight shape. These wedges are intended to press the matrix band against the tooth to be treated. In this case, a tangential point of contact can be established which to a certain degree permits closure of the gap between the matrix band and the neck of the tooth. However, in this case too, a residual gap still remains in front of and behind this point of contact.

Another purpose of interdental wedges is to press the adjacent teeth at the treatment site slightly apart. This is done such that a contact point between the two teeth can be produced after removal of the matrix band and of the wedge. The contact point is located slightly below the plane of the occlusal surface and has been designed by nature to ensure that no remnants of food can be pressed between the teeth during mastication. The recovery of the contact point is one of the aims of the restoration of a diseased tooth.

### SUMMARY OF THE INVENTION

The object of the present invention is to make available an interdental wedge of the type mentioned at the outset which, when used with a matrix in connection with a filling procedure, is able to provide a sealing action against the gingival escape of filling material and/or is able to permit a sealed arrangement and use of a rubber dam, and, if appropriate, allows a force effect to build up between the tooth to be treated and the adjacent tooth, in order to make it possible to establish a contact point.

According to the invention, an interdental wedge is proposed for use with a matrix band when preparing a filling on a tooth to be restored and/or for use with a rubber dam, by inserting the interdental wedge into an area near the gingiva between the tooth to be restored or to be treated and an adjacent tooth, with an insertion area having a cross section delimited by a lower face, by an inner face and by an outer face, wherein, in the state inserted near the gingiva, the lower face is directed towards the gum, the inner face is directed towards the tooth to be restored or to be treated, and the outer face is directed towards the adjacent tooth, wherein the inner face and the lower face run together in an edge, which is designed such that, in the state inserted near the gingiva, it bears on the tooth to be restored or to be treated, in order to provide a sealing action against passage of material.

The invention is based on the knowledge that, in connection with the use with a matrix in filling procedures, it is not only possible for an interdental wedge to be used to provide a seal against passage of material by pressing against a point or area of the matrix band facing directly towards the neighbouring tooth, but instead the interdental wedge itself can be used to provide the seal, in which case a leak in the gingival area is minimized by an edge of the wedge, in addition to or alternatively to the pressing action of the matrix band. The effect of the interdental wedge according to the invention is not necessarily to press the matrix band with a spring force against the tooth along a relatively long stretch. A sealing action is achieved by an edge of the interdental wedge bearing on the tooth itself. In this way, the pressing force required in known interdental wedges in relation to the matrix is necessary only to a lesser extent, the force effect being directed mainly towards pressing the adjacent teeth apart in order to permit the contact point. For the production of the interdental wedge, this makes it possible to use a wider range of possible materials, which also includes commercially available plastics. Regardless of this, however, the interdental wedge according to the invention can also be designed such that, in addition to the sealing action of the edge, a sealing action is achieved already when the matrix band is pressed onto the (residual) tooth, that is to say the sealing actions of the edge and of the pressed-on matrix band come together.

With an interdental wedge of relatively low strength (e.g. because it is made of a thin plastic), it has been found that it is possible only with difficulty to deform a matrix band across a wide area with sufficient efficacy to achieve a seal. However, stronger materials entail a risk of damage to the treated or adjacent tooth.

It has also been found that the interdental wedge according to the invention can also be used advantageously in endodontic treatment using a rubber dam.

Advantageous developments of the invention are set forth in particular in the dependent claims.

In an advantageous embodiment, the insertion area tapers at least partially in the direction of a tip of the insertion area. The fact that the cross section become smaller towards the tip of the insertion area means that it is easier to insert the interdental wedge into the interdental space.

In another embodiment, the inner face is at least partially concave and the outer face is at least partially convex. A concave shape, i.e. an inwardly curved or at least indented shape, of the inner face results in good adaptation to the tooth shape.

In another embodiment, the lower face is at least partially concave, this configuration of the lower face, particularly in a shape similar to the hollow ground surface of an ice skate, promoting the sealing action of the edge. This also means that the inwardly curved edge of the interdental wedge acquires a certain additional flexibility. It has also been found that, with a concave shape of the lower face, there is generally less risk of injury to the anatomical structure (col) lying between the teeth. Particularly preferably, the lower face has a convexity that corresponds to a radius in the range of twice the height of the interdental wedge to one fifth of the height of the interdental wedge in the respective cross section. In one configuration, with a maximum height (depending on the size range of the interdental wedge) of the insertion area of 1.5 to 3.5 mm, a radius of the convex lower face in the range of 0.5 to 4.0 mm is provided at the same location.

Preferably, a corner radius of the edge lies in the range of 0.01 to 0.3 mm. It has been found that, with some materials, the sealing ability of the edge decreases with a greater corner radius or edge radius. Moreover, too narrow an edge radius can form an unintended blade edge and/or pose a risk of injury, although it has been found that, even with a corner radius of 0.01 to 0.05 mm, risk of injury is manageable with suitably careful use of the interdental wedge. Relative to the maximum height of the insertion area of the interdental wedge, a corner radius in the range of 0.5% to 15% is preferred in particular, and the range of 0.5% to 5% is particularly preferable.

In a preferred embodiment, the insertion area is at least partially curved in the direction of the inner face, resulting in an anatomical adaptation of the interdental wedge to the tooth shape, which leads overall to an improved bearing of the interdental wedge on the tooth.

In another advantageous embodiment, the lower face is at least partially curved in the direction of the transition between inner face and outer face. In particular in combination with the curvature of the interdental wedge in the direction of the inner face, this therefore results in further approximation to the natural shape of the tooth in the area where the interdental wedge is intended to bear on the tooth and provide a pressing action. The lower face preferably has a curvature in the direction of the transition between inner face and outer face corresponding to a radius in the range of 10 to 30 mm, alternatively a radius in the range of four times to ten times the maximum height of the insertion area of the interdental wedge as a whole.

In another embodiment, the interdental wedge according to the invention has a limiting area, which is adjacent to the insertion area and has a larger cross section than the insertion area in order to limit a depth of insertion of the insertion area in the longitudinal direction into the area near the gingiva. With the aid of the limiting area, it is easily possible to ensure that the interdental wedge is not inserted too deep or too far between the teeth, since the limiting area abuts on the adjacent teeth and thus prevents further insertion. In addition to ensuring that no damage arises as a result of the interdental wedge being inserted too deep or too far, this embodiment has the further advantage that a desired area protrudes from the interdental space, by means of which the interdental wedge can be removed again.

In one embodiment, the edge is located at the end of a sealing lip, in particular a sealing lip with a substantially constant thickness. It has been found that, with the aid of an area that extends from the main body to the edge, an advantageous sealing action can be achieved, especially if this area is in the shape of a sealing lip, in which case the thickness, orientation and material of the sealing lip can be used in a simple way to influence the force with which the edge is placed onto the tooth.

In another embodiment, the inner face has at least partially, in addition to the edge, a protruding sealing area which is designed such that, in the state of insertion of the interdental wedge near the gingiva, it bears on the tooth to be restored or to be treated, in order to provide a sealing action against passage of material. With a multi-stage seal composed of edge and sealing area, any remaining amount of material that has passed through can be further reduced.

In another embodiment, the interdental wedge has, in an edge area, less strength and/or greater elasticity than in an area outside the edge area. The edge area and the area outside the edge area have different main purposes during use, and targeted adaptation of the respective material properties brings advantages.

In the aforementioned embodiment, the edge area can be made of another material than the area outside the edge area, wherein the interdental wedge can be produced in particular by a multi-component injection moulding technique. In such a technique, different materials can be combined with one another in a relatively simple way in order thereby to optimize the properties of the interdental wedge as a whole.

### BRIEF DESCRIPTION OF THE DRAWINGS

The present invention is explained in more detail below with reference to the attached figures, in which:

FIG. 1 shows a first illustrative embodiment of an interdental wedge according to the invention in a general view and in selected cross-sectional views (FIGS. 1A-1C),

FIG. 2 shows a second illustrative embodiment of an interdental wedge according to the invention in a general view and with different design alternatives (FIGS. 2a-2c),

FIG. 3 shows an interdental wedge according to the invention in the state inserted near the gingiva,

FIG. 4 shows another illustrative embodiment of an interdental wedge according to the invention in a general view and in a cross-sectional view,

FIG. 5a and FIG. 5b show other illustrative embodiments of interdental wedges according to the invention,

FIG. 6 shows an illustrative embodiment of a support with interdental wedges according to the invention, in a perspective view and in a side view of a detail.

### DETAILED DESCRIPTION

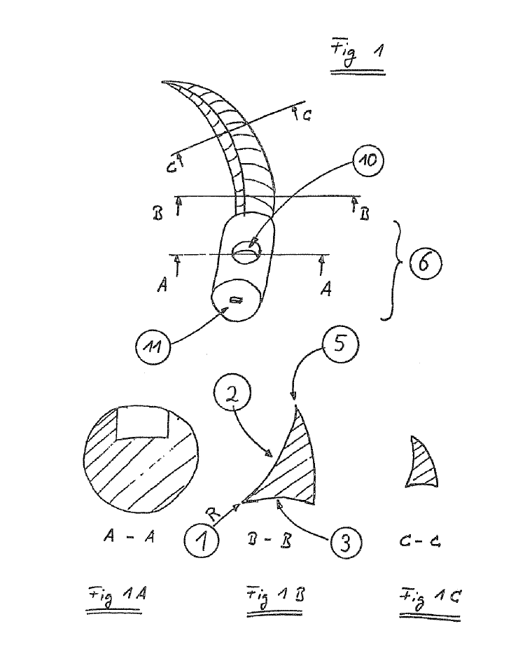

An illustrative embodiment of an interdental wedge according to the invention is shown in FIG. 1. The interdental wedge depicted is made of plastic and has a contour curved in all 3 spatial planes.

The interdental wedge shown comprises an insertion area of substantially triangular cross section, and an in this case circular limiting area 6 of larger cross section, which also serves as a gripping area of the interdental wedge. The cross-sectional views shown in FIGS. 1A-1C are indicated in FIG. 1.

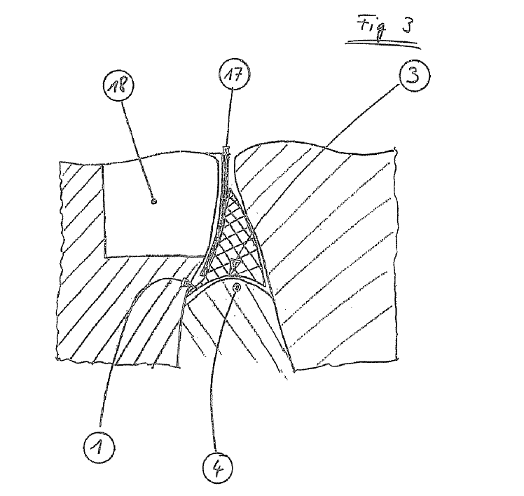

To ensure that it can transfer a sufficient compressive force for the treatment (mainly for pressing apart the adjacent teeth (see FIG. 3)), the main body is made of a relatively strong plastic. The use of polystyrene or ABS is proposed, although other suitable plastics can also be used. The modulus of elasticity of the main plastics provided is preferably between 200 MPa and 10,000 MPa.

On its inner face 2, that is to say on the face directed towards the tooth to be treated (cf. FIG. 3), the interdental wedge has an area that functions as sealing edge 1. This sealing edge is pointed here, in other words has a very narrow edge radius or corner radius R. The edge radius is preferably 0.01 to 0.3 mm.

The sealing edge 1 results from the running together of the inner face 2 and of the lower face 3, both the inner face 2 and the lower face 3 being concave (see in particular FIG. 1B and FIG. 1C), that is to say curving in the direction of the interior of the interdental wedge.

It will be noted that, in the illustrative embodiment shown, the curvature of the outer surfaces (i.e. lower face 3, inner face 2 and outer face) is constant in cross section through the interdental wedge, although the present invention is not limited to concave or convex surfaces of this kind. For example, the curvature of one or more faces can also be non-constant. Moreover, the outer surfaces can be at least partially designed such that there is no curvature in the cross section.

The overall shape of the interdental wedge illustrated in FIG. 1 results from the cross section with the concave inner face 2 and the likewise convex lower face 3, while the cross section is closed with the in this case convex outer face. As can also be seen from FIG. 1, the interdental wedge is also curved in its longitudinal direction in the direction of its inner face 2, wherein the interdental wedge also tapers in the direction of a tip which, during use, is the first part to be inserted into the gingival area. In this way, the concave inner face 2 and the outer face are each obtained as surfaces curved on two axes. Moreover, the lower face 3 curves upwards towards the tip in approximately a third of the insertion area, such that, in addition to the curvature of the interdental wedge in the direction of its inner face 2, there is also a partial curvature of the interdental wedge away from the lower face 3.

If the respective area centroids of adjacent cross sections through the insertion area of the interdental wedge from FIG. 1 are considered as a line, this line is curved in the direction of the inner face 2 according to the curvature of the interdental wedge as a whole, and there is also a curvature of this line away from the lower face 3. Alternatively, the profile of the area centroids can also be such that the line described therewith has an upward kink, which results from the profile of the tapering and of the curvature of the insertion areas away from the lower face 3.

By virtue of its shape, the area of the edge 1 is flexible and can thus easily adapt to small irregularities of the natural tooth surface and thus guarantees seamless sealing. Since the plastic in the area of the edge of the interdental wedge is substantially flexible, the ability to build up a sufficient compressive force is not adversely affected.

When using interdental wedges, it is important that they are used the correct way, i.e. with the lower face 3 directed towards the gum (cf. FIG. 3). If an interdental wedge of the form shown were to be used with the pointed upper edge 5 opposite the lower face 3 directed towards the gum, this could irritate or even damage the gum.

On the upper face of the gripping section 6 of the interdental wedge shown in FIG. 1, lying opposite the lower face 3, there is a marking 10. This marking ensures that the dentist can clearly recognize the upper face within the confined space in the oral cavity and therefore prevents the interdental wedge from being inserted the wrong way round. In this example, the marking is in the form of a circle, but it can also have any other form. In addition or alternatively to this, it is possible for that face of the gripping section 6 corresponding to the lower face to be provided with a (further) marking, for example in the form of an “X”, which serves the same purpose.

The one or more markings can at the same time serve to provide a better gripping surface for removal. It is also possible for further markings to be provided, e.g. offset by 90°.

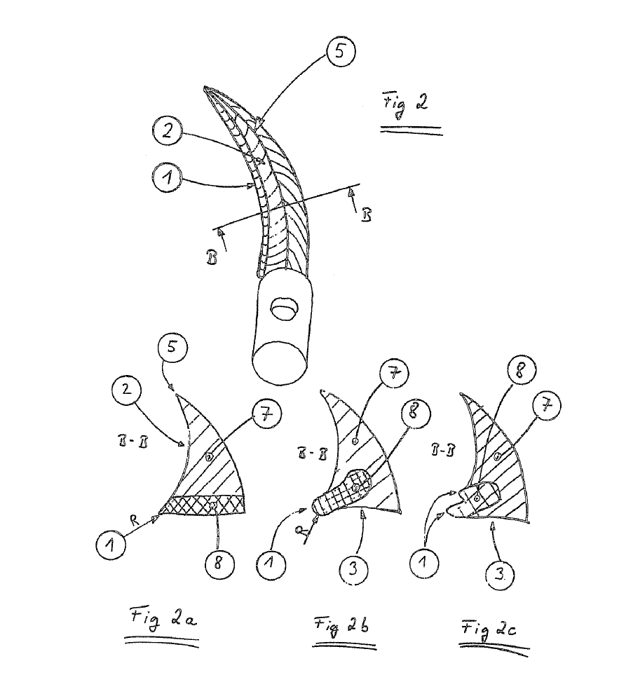

Another illustrative embodiment of an interdental wedge according to the invention is shown in FIG. 2. The interdental wedge shown in FIG. 2 corresponds substantially to the illustrative embodiment discussed with reference to FIG. 1, but it is made from different plastics. Such an interdental wedge can be produced by the two-component injection moulding technique known to a person skilled in the art.

The insertion area in this case comprises a main body 7 made of a first, relatively strong plastic that is able to deploy a certain elasticity and is above all able to transfer a desired or necessary compressive force. The main body 7 makes up most of the insertion area (cf. the cross-sectional alternatives shown in FIG. 2a to FIG. 2c). By contrast, an edge area 8, which comprises the edge 1 of the interdental wedge, is made of a second plastic which is softer than the first plastic and is flexible and elastic and therefore permits further improved sealing. The soft plastic can, for example, be a thermoplastic elastomer or a silicone. The proposed Shore hardness is preferably between 20 Shore D and 80 Shore D.

FIGS. 2a to 2c show different possibilities for the design of the sealing edge 1 and of the edge area 8.

In the embodiment shown in FIG. 2a, the lower face 3 is flat in cross section, although this would not exclude an at least partial curvature of the lower face in the longitudinal direction of the interdental wedge. Here, the desired flexibility of the edge 1 is obtained primarily through the softer plastic of the edge area 8, which in this case extends across the entire lower cross section along the lower face 3.

The edge has a rounded configuration in FIG. 2b, while the lower face 3 is once again concave. In contrast to FIG. 2a, the edge area 8 in the option depicted in FIG. 2b is for a large part enclosed by the main body 7 and extends out of the main body 1 in the area of the edge 1. For better anchoring in the main body, the edge area can have a thickening in the inside.

Likewise as in FIG. 2b, the edge area 8 in FIG. 2c is also substantially enclosed by the main body 7, although in the alternative depicted in FIG. 2c a double sealed edge is provided consisting of edge 1 and of an additional sealing area.

It will be noted that the configurations of the edge shape in the illustrative embodiments shown in all the figures are not limited to the respective illustrative embodiment, and therefore the invention can also be implemented, for example, in the geometry of the illustrative embodiment of FIG. 1 in a multi-component variant according to FIG. 2. Moreover, the design of the edge 1 and of the edge area 8 does not have to be the same along the entire length of the insertion area, and therefore various aspects of edge embodiments and of edge area embodiments can also be combined in an interdental wedge according to the invention.

FIG. 3 shows a cross-sectional view of an interdental wedge according to the invention during use when preparing a filling. A matrix band 17 is shown which, in its lower area, is pushed by the interdental wedge against the tooth prepared for restoration, the interdental wedge having been inserted into the area between the tooth to be restored and the adjacent tooth. An area 18 of the tooth is prepared for the filling. It will also be seen that the edge 1 of the interdental wedge seals off the gap (between the tooth and the matrix band 17) remaining under the matrix band 17. In addition to the concave shape of the lower face 3 improving the sealing action and flexibility of the edge 1, FIG. 3 also shows the further advantage of this embodiment, namely that the interdental wedge is advantageously adapted to the shape of the gum 4 between the teeth.

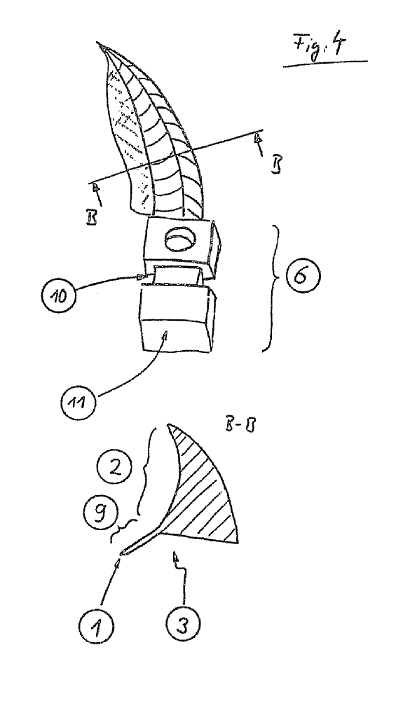

Another possible way of achieving the desired sealing effect is for the interdental wedge according to the invention to be provided, on its inner face directed towards the tooth to be treated, with a thin sealing lip 9, at the tip of which the edge 1 is provided. This illustrative embodiment is shown in FIG. 4, where the lower face, in a special example of a concave shape, has a “kink”. The sealing lip 9 extends, with substantially constant thickness in cross section, from the main body of the interdental wedge as far as the edge 1 provided at the end (see cross section B-B in FIG. 4), and it can in particular also be effectively provided if the interdental wedge (or the insertion area) is made only of a single material. A person skilled in the art can readily choose the material for this extension from the available possibilities. However, it should be noted that the plastic has to be able to transfer the necessary or desired compressive force. Provision is additionally made that the sealing lip 9 has a sufficient ability to deform without breaking or tearing. Many of the known plastics, in contrast to other classes of material such as metals or wood, afford these possibilities. Polypropylene, impact-resistant ABS, polyethylene or polyamide are mentioned as examples, without this list being exhaustive.

In a departure from the illustrative embodiments depicted in FIG. 1 and FIG. 2, the interdental wedge shown in FIG. 4 has, at its proximal end 11, a non-wedge-shaped thickening 6, which serves as a gripping section and is in this case cube-shaped and also has a recess 10.

The thickening, which can advantageously serve to limit the depth of insertion of the insertion area, can be cylindrical or cuboid, for example, or of any other shape.

In this example, the thickening serves the purpose of ensuring that the wedge is not pushed too far into the interdental space, and it also has the function of a gripping surface for removing, i.e. pulling out, the interdental wedge.

To do this, the interdental wedge according to the invention, in the same way as with known interdental wedges, is gripped using a tool such as a small pair of forceps or pincers and pulled out.

To ensure that the tool does not simply slip off, the interdental wedge according to the invention has, in this example, a recess 10, which permits a form-fit introduction of force. A plurality of recesses can also be provided.

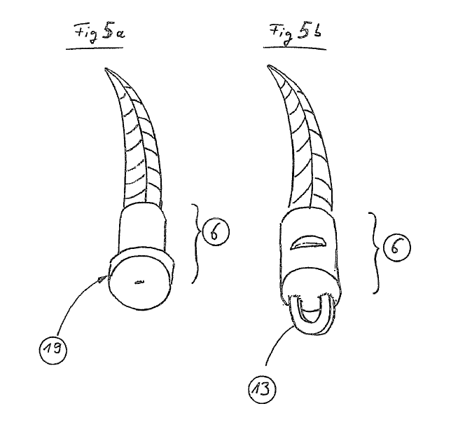

It is also possible that the proximal end of the interdental wedge has, for example, a cylindrical shoulder 19 with a greater diameter, as is shown in FIG. 5a. This has the advantage of permitting form-fit engagement with a tool such as pincers in any position, something that a recess located in a single position is less able to permit.

The same purpose would also be served by another cross section, for example a polygonal cross section, with a circumferential groove. This is shown in FIG. 4.

Other possible ways of pulling out the interdental wedge are also conceivable, one such way being, for example, to provide an eyelet 13, as is shown in FIG. 5b.

Insofar as a curvature is provided in the direction of the inner face 2, the interdental wedges according to the invention can be provided both with a right curve and also a left curve.

It is recommended in practice to provide the various embodiments in distinct shades. For example, shades of blue for those with a left curve and shades of yellow for those with a right curve.

Since the interdental area has a different width in each person and also between each tooth, it is expedient also to provide interdental wedges in different sizes. For rapid and easy differentiation of size, it is possible to provide a variation in the principal shade, for example from light shades for small sizes to dark shades for large sizes.

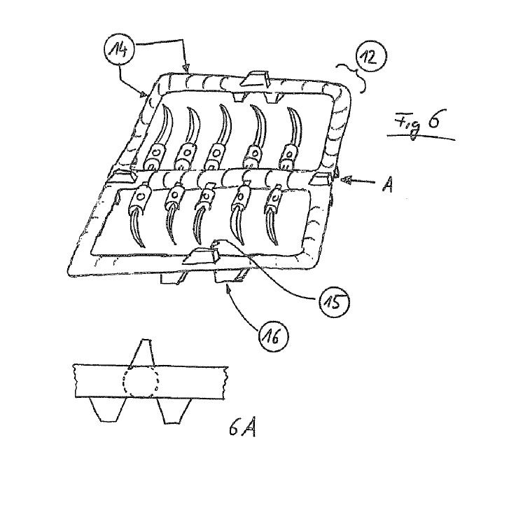

The interdental wedges according to the invention can be arranged in large number in a common support 12. Such an arrangement is shown in FIG. 6. This support can be produced together with the wedges in an injection moulding technique. The support and wedges are therefore initially provided in one piece. The connection between the wedges and the support is a thin plastic film or web, which functions as a predetermined break point. A single wedge can be broken off for use in each case. This type of provision of the interdental wedges is also expedient from the point of view of hygiene, since a wedge that has already been used cannot inadvertently be put back, which can happen for example if they are stored loose.

The support has a circumferential protective edge 14 located in front of the wedge tips. This serves to protect the sensitive wedge tips from being accidentally buckled during storage or transport. Such a support is shown in FIG. 6 in a substantially square shape. A round shape or any other shape is likewise possible.

In this example, the support also carries important information for the use of the wedges contained therein.

To be able to store a large number of supports together, the support according to the invention has a stacking aid 15, 16. In FIG. 6, projections engaging in one another can be seen at four locations on the upper face and also on the lower face and ensure secure stacking.

The present invention relates in particular to an interdental wedge made of plastic with a proximal end and a distal end and with a substantially triangular cross section in an insertion area, wherein a lower face of the interdental wedge lies on a surface curved on at least one axis, and the profile of an area centroid of the cross sections from the proximal end to the distal end follows a second surface curved on at least one axis, wherein the two axes are perpendicular to each other and the cross section grows smaller from the proximal end to the distal end and the inwardly curved face has an edge. The edge present on the inwardly curved face is preferably a sealing edge and is suitable for engaging under the edge of a metal matrix and for closing a gap there. Provision can be made that the wedge is composed of two different materials, and the area that forms the edge provided for sealing is softer and/or more flexible than the remaining area. Another possibility is that the edge provided for sealing is equipped with one or more flexible lips. The edge radius of the inwardly curved edge provided for bearing on the tooth is advantageously smaller than 0.3 mm. Moreover, the curvature of the lower face from the proximal end to the distal end can be downwardly directed in various sections and also upwardly directed in other sections. At the proximal end, the interdental wedge according to the invention can have means that can be gripped by a tool so as to pull the wedge back out from a firmly wedged position in the interdental area, these means serving as a gripping section. In particular, recesses can be located on the gripping section located at the proximal end and used for pulling out, which recesses permit a form-fit introduction of force when gripped with forceps. Moreover, on a face lying opposite the lower face, the gripping section can have a marking to permit orientation of the interdental wedge. The interdental wedge according to the invention can be made available in a design with a curvature to the left and in a design with a curvature to the right. The two directions of curvature are preferably identified by distinct shades of colour. In addition, different sizes of the design with a curvature to the left and of the design with a curvature to the right are advantageously provided, the different sizes being identified in particular by different tints or closely similar shades. For easier handling, provision can be made that a large number of identical or also different wedges are arranged on a common support and can be detached for use, wherein the support preferably has means that permit stacking. It is advantageous in particular if the support is made of the same basic plastic material as the wedges and is produced in one piece with the wedges, in which case the individual wedges can be broken off for removal.

The support can be substantially round and can have a protective ring that protects the wedge tips from damage during storage and transport, the carrier additionally or alternatively being provided with information relating to the design of the respective interdental wedges or to the use thereof.

1. Interdental wedge for use with a matrix band when preparing a filling on a tooth to be restored and/or for use with a rubber dam, by inserting the interdental wedge into an area near the gingiva between the tooth to be restored or to be treated and an adjacent tooth, comprising:
an insertion area having a cross section delimited by a lower face, by an inner face and by an outer face, wherein, in the state inserted near the gingiva, the lower face is directed towards the gum, the inner face is directed towards the tooth to be restored or to be treated, and the outer face is directed towards the adjacent tooth,
wherein the inner face and the lower face run together in an edge, which is designed such that, in the state inserted near the gingiva, it bears on the tooth to be restored or to be treated, in order to provide a sealing action against passage of material.

2. Interdental wedge according to claim 1, wherein the insertion area at least partially tapers in the direction of a tip of the insertion area.

3. Interdental wedge according to claim 1, wherein the inner face is at least partially concave and the outer face is at least partially convex.

4. Interdental wedge according to claim 1, wherein the lower face is at least partially concave.

5. Interdental wedge according to claim 1, wherein a corner radius of the edge lies in the range of 0.01 to 0.3 mm.

6. Interdental wedge according to claim 1, wherein the insertion area is at least partially curved in the direction of the inner face.

7. Interdental wedge according to claim 1, wherein the lower face is at least partially curved in the direction of the transition between inner face and outer face.

8. Interdental wedge according to claim 1, also with a limiting area, which is adjacent to the insertion area and has a larger cross section than the insertion area in order to limit a depth of insertion of the insertion area in the longitudinal direction into the area near the gingiva.

9. Interdental wedge according to claim 1, wherein the edge is located at the end of a sealing lip, in particular a sealing lip with substantially constant thickness.

10. Interdental wedge according to claim 1, wherein the inner face has at least partially, in addition to the edge, a protruding sealing area which is designed such that, in the state of insertion of the interdental wedge near the gingiva, it bears on the tooth to be restored or to be treated, in order to provide a sealing action against passage of material.

11. Interdental wedge according to claim 1, wherein the interdental wedge has, in an edge area, less strength and/or greater elasticity than in an area outside the edge area.

12. Interdental wedge according to claim 11, wherein the edge area is made of another material than the area outside the edge area, wherein the interdental wedge is produced in particular by a multi-component injection moulding technique.
